(19) United States
(12) Patent Application Publication
(10) Pub. No.: US 2025/0128955 A1
(43) Pub. Date: Apr. 24, 2025

(54) METHODS OF PREPARING ALUMINUM OXIDE

(71) Applicant: Saudi Arabian Oil Company, Dhahran (SA)

(72) Inventors: Ibrahim Al-Zahrani, Al-Dammam (SA); Wala Algozeeb, Alkhobar (SA)

(21) Appl. No.: 18/492,228

(22) Filed: Oct. 23, 2023

(51) Int. Cl. C01F 7/30

(52) U.S. Cl. CPC C01F 7/30

(57) ABSTRACT

A method of preparing aluminum oxide includes calcining a spent Claus catalyst, wherein the catalyst includes at least 75% alumina compounds.

A method of preparing aluminum oxide includes calcining a mixture of alumina compounds, wherein the alumina compounds comprise bochmite, γ-aluminum oxide, corundum, and gibbsite.

### FIELD

The disclosure relates a method of preparing aluminum oxide from a spent Claus catalyst.

### BACKGROUND

Alumina can be used as a precursor for aluminum metal production. Alumina is typically produced from bauxite, which is a naturally occurring mineral mixture. Bauxite is composed of hydrated aluminum oxides, hydrated aluminosilicates, iron oxides, hydrated iron oxides, titanium oxide, and silica. Bauxite contains mixtures of various minerals such as gibbsite, boehmite, hematite, goethite, Al-goethite, anatase, rutile, ilmenite, kaolin, and quartz. The presence of large amounts of metals along with the aluminum oxide mandate the need for processing bauxite to produce high purity aluminum oxide. The Bayer process for refining bauxite to produce alumina is chemically intensive, requires the utilization of large amounts of caustic acids and bases, and can have a large environmental footprint. After removing silica, bauxite is mixed with hot caustic soda to dissolve the aluminum-based chemicals, which are then crystallized to get aluminum hydroxide. The aluminum hydroxide crystals are then collected and calcined to get high purity alumina, generating large amounts of hazardous waste named red mud. For each ton of alumina produced by the Bayer process, two tons of red mud are produced. Therefore, there is a need for producing alumina with a reduced environmental footprint.

### SUMMARY

The disclosure relates to a method of preparing aluminum oxide. In one aspect, the method includes calcining a spent Claus catalyst. The catalyst includes at least 75% alumina compounds.

In another aspect, a method of preparing aluminum oxide includes calcining a mixture of alumina compounds. In certain embodiments, the alumina compounds include boehmite, γ-aluminum oxide, corundum, and gibbsite.

### BRIEF DESCRIPTION OF THE FIGURES

FIG. 1 depicts an example method of preparing aluminum oxide from bauxite.

FIG. 2 depicts an embodiment of a method disclosed herein.

FIG. 3 is an XRD pattern of a spent Claus catalyst sample with reference patterns of identified chemical compounds.

FIG. 4 shows the TGA of a spent Claus catalyst upon heating in air.

### DETAILED DESCRIPTION

Unless otherwise defined, all technical and scientific terms used in this document have the same meaning as commonly understood by one of ordinary skill in the art to which the present application belongs.

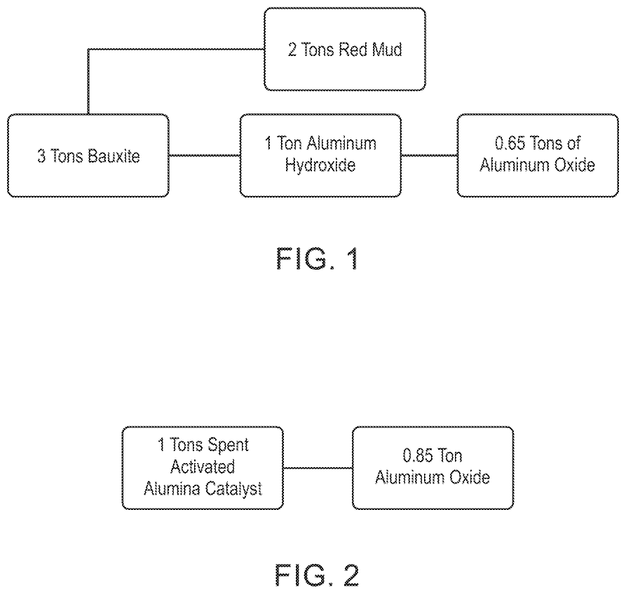

The method disclosed herein provides a method for alumina production from a spent Claus catalyst. In some embodiments, the method requires less processing as compared to bauxite, generates less to no waste, and can produce a higher yield of alumina as compared to bauxite processes. FIG. 1 shows an example process that is typically used to produce alumina from bauxite. This process utilizes 3 tons of bauxite to produce 0.65 tons of aluminum oxide, and 2 tons of red mud as a byproduct. FIG. 2 shows an example embodiment of the method provided herein, wherein 1 ton of spent Claus (activated alumina) catalyst can be used to generate 0.85 tons of aluminum oxide, without generating red mud as a byproduct.

Claus catalyst is an activated alumina catalyst that can be generated in large quantities, and spent catalysts are commonly disposed in landfills. The method provided herein utilizes spent Claus catalysts to generate a feed for aluminum metal production, and can result in high yield of high-quality alumina. The method can lead to a reduction in detrimental environmental impacts for this process, as well as a reduction in costs associated with landfilling.

Provided herein is a method of preparing aluminum oxide comprising calcining a spent Claus catalyst, wherein the catalyst comprises at least 75% alumina compounds. The terms “aluminum oxide” and “alumina” are used interchangeably throughout the disclosure to refer to Al₂O₃.

As used herein, a “spent catalyst” refers to a catalyst that is removed from a reactor after completing its lifetime in the reactor, or is expired for any reason (e.g., due to sun exposure). In other words, a “spent catalyst” includes any catalyst that needs to be disposed of.

In some embodiments, the calcining comprises heating at a temperature of at least 450° C. In some embodiments, the calcining comprises heating at a temperature greater than 450° C. In some embodiments, the calcining comprises heating at a temperature in a range of about 450° C. to about 650° C.

In some embodiments, the calcining is carried out for a time between about 30 seconds and about 3 hours, about 30 seconds and about 1 hour, or about 1 minute and about 20 minutes. In some embodiments, the calcining is carried out for a time between about 5 minutes and about 15 minutes.

In some embodiments, the spent Claus catalyst comprises at least about 80 wt. % alumina compounds, at least about 85 wt. % alumina compounds, at least about 90 wt. % alumina compounds, at least about 95 wt. % alumina compounds, or at least about 99 wt. % alumina compounds. “Alumina compounds,” as used herein, refer to oxides or hydroxides of aluminum and can include aluminum oxide minerals. In some embodiments, the alumina compounds are essentially free of bauxite.

The methods provided herein can increase the aluminum oxide content of the alumina compounds. In some embodiments, the alumina compounds comprise aluminum oxide hydroxide. In some embodiments, the calcination process converts the aluminum oxide hydroxide (AlO(OH)) to aluminum oxide, which results in an aluminum oxide enriched product.

In some embodiments, the alumina compounds comprise boehmite, γ-aluminum oxide, corundum, gibbsite, or a combination thereof. In some embodiments, the alumina compounds include boehmite, corundum, and gibbsite.

In some embodiments, the alumina compounds comprise boehmite (γ-AlO(OH)). In some embodiments, the spent Claus catalyst comprises about 30 wt. % to about 70 wt. % boehmite, about 35 wt. % to about 65 wt. % boehmite, about 40 wt. % to about 60 wt. % boehmite, or about 40 wt. % to about 55 wt. % boehmite, about 40 wt. % to about 50 wt. % boehmite, or about 44 wt. % to about 49 wt. % boehmite.

In some embodiments, the alumina compounds comprise γ-aluminum oxide (e.g., γ-Al₂O₃). In some embodiments, the spent Claus catalyst comprises about 20 wt. % to about 60 wt. % γ-aluminum oxide, about 30 wt. % to about 50 wt. % γ-aluminum oxide, about 30 wt. % to about 45 wt. % γ-aluminum oxide, or about 35 wt. % to about 40 wt. % γ-aluminum oxide.

In some embodiments, the alumina compounds comprise corundum (Al₂O₃). In some embodiments, the spent catalyst comprises about 1 wt. % to about 30 wt. % corundum, about 5 wt. % to about 25 wt. % corundum, about 10 wt. % to about 20 wt. % corundum, or about 10 wt. % to about 15 wt. % corundum.

In some embodiments, the alumina compounds comprise gibbsite (α-Al(OH)₃). In some embodiments, the catalyst comprises about 0.01 wt. % to about 5 wt. % gibbsite, or about 0.1 wt. % to about 2 wt. % gibbsite.

In some embodiments, the catalyst includes about 35 wt. % to about 65 wt. % boehmite, about 30 wt. % to about 50 wt. % γ-aluminum oxide, about 5 wt. % to about 25 wt. % corundum; and about 0.01 wt. % to about 5 wt. % gibbsite. In some embodiments, the composition of the catalyst is determined by XRD.

In some embodiments, the method provides at least 65% yield, at least 75% yield, or at least 85% yield of the aluminum oxide. The % yield refers to the percentage of catalyst (by weight) remaining after calcination. The % yield is calculated as: (mass of catalyst after calcination)/(mass of catalyst before calcination)*100.

In some embodiments, the method produces aluminum oxide and water. In some embodiments, the only byproduct is water. In some embodiments, the method does not generate red mud as a byproduct.

Also provided herein is a method of preparing aluminum oxide comprising calcining a mixture of alumina compounds, wherein the alumina compounds comprise boehmite, γ-aluminum oxide, corundum, and gibbsite. In some embodiments, the calcination increases the amount of aluminum oxide in the mixture.

In some embodiments, the calcining comprises heating at a temperature of at least 450° C. In some embodiments, the calcining comprises heating at a temperature greater than 450° C. In some embodiments, the calcining comprises heating at a temperature in a range of about 450° C. to about 650° C.

In some embodiments, the calcining is carried out for a time between about 30 seconds and about 1 hour, or about 1 minute and about 20 minutes. In some embodiments, the calcining is carried out for a time between about 5 minutes and about 15 minutes.

In some embodiments, the mixture comprises at least about 80 wt. % alumina compounds, at least about 85 wt. % alumina compounds, at least about 90 wt. % alumina compounds, at least about 95 wt. % alumina compounds, or at least about 99 wt. % alumina compounds. In some embodiments, the mixture is essentially free of bauxite.

In some embodiments, the mixture comprises about 30 wt. % to about 70 wt. % boehmite, about 35 wt. % to about 65 wt. % boehmite, about 40 wt. % to about 60 wt. % boehmite, or about 40 wt. % to about 55 wt. % boehmite, about 40 wt. % to about 50 wt. % boehmite, or about 44 wt. % to about 49 wt. % boehmite.

In some embodiments, the mixture comprises about 20 wt. % to about 60 wt. % γ-aluminum oxide, about 30 wt. % to about 50 wt. % γ-aluminum oxide, about 30 wt. % to about 45 wt. % γ-aluminum oxide, or about 35 wt. % to about 40 wt. % γ-aluminum oxide.

In some embodiments, the mixture comprises about 1 wt. % to about 30 wt. % corundum, about 5 wt. % to about 25 wt. % corundum, about 10 wt. % to about 20 wt. % corundum, or about 10 wt. % to about 15 wt. % corundum.

In some embodiments, the mixture comprises about 0.01 wt. % to about 5 wt. % gibbsite, or about 0.1 wt. % to about 2 wt. % gibbsite.

In some embodiments, the mixture comprises about 35 wt. % to about 65 wt. % boehmite, about 30 wt. % to about 50 wt. % γ-aluminum oxide, about 5 wt. % to about 25 wt. % corundum; and about 0.01 wt. % to about 5 wt. % gibbsite. In some embodiments, the composition of the mixture is determined by XRD.

Also provided herein is a method of increasing an amount of aluminum oxide in a sample comprising calcining the sample. In some embodiments, the sample comprises a spent Claus catalyst. In some embodiments, the sample comprises about 35 wt. % to about 65 wt. % boehmite, about 30 wt. % to about 50 wt. % γ-aluminum oxide, about 5 wt. % to about 25 wt. % corundum; and about 0.01 wt. % to about 5 wt. % gibbsite.

The methods provided herein can have applications in aluminum metal production. In some embodiments, the aluminum oxide prepared by the method is utilized as a feed for aluminum metal production.

As used in this disclosure, the term “about” can allow for a degree of variability in a value or range, for example, within 10%, within 5%, or within 1% of a stated value or of a stated limit of a range.

As used in this disclosure, the term “essentially free” can refer to less than 5 wt. %, less than 1 wt. %, less than 0.01 wt. %, or less than 0.001 wt. %.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited.

Particular embodiments of the subject matter have been described. Other implementations, alterations, and permutations of the described embodiments are within the scope of the following claims as will be apparent to those skilled in the art.

### EXAMPLES

### Example 1: Characterization of Spent Claus Catalyst

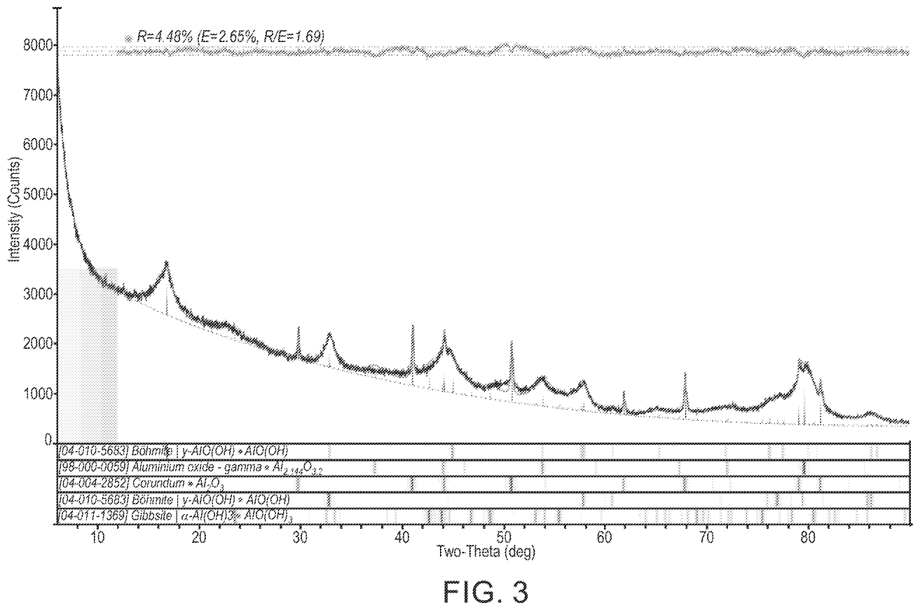

Spent activated alumina catalyst was characterized by XRD to determine the chemical composition of the sample. The results showed that the sample was 100% composed of aluminum-based compounds as shown in FIG. 3. Table 1 shows the composition of the sample.

TABLE 1

| Phase Composition | Wt. % |
|---|---|
| Boehmite [γ-AlO(OH)] | 44 |
| γ-Aluminum Oxide [Al_{2.144}O_{3.2}] | 38 |
| Corundum [Al₂O₃] | 12 |
| Boehmite [γ-AlO(OH)] | 5 |
| Gibbsite [∝-Al(OH)₃] | 1 |

Although the two entries in Table 1 for boehmite are the same chemically, two different XRD patterns profiles were used to fit the XRD curves properly.

The levels of toxic elements were tested via toxicity characteristic leachate procedure (TCLP) to reveal that the spent activated alumina has undetectable levels of heavy metals.

### Example 2: Thermal Gravimetric Analysis (TGA) of a Spent Claus Catalyst

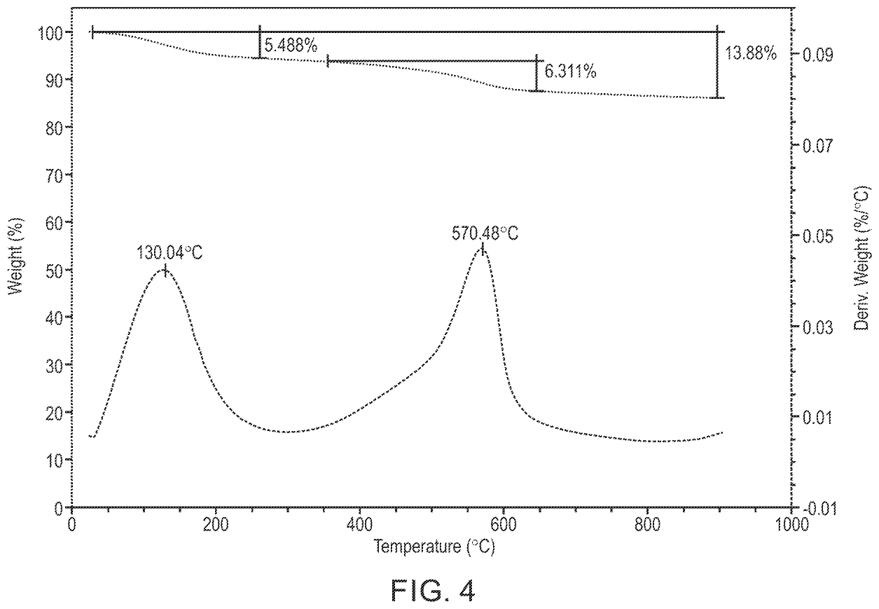

The yield of the aluminum oxide upon calcination was determined via thermal gravimetric analysis (TGA) to show that the spent catalyst sample experiences around 15% loss in weight upon heating in air up to 600° C., as shown in FIG. 4, due to water loss. This means that the aluminum oxide yield from spent activated catalyst can be about 85%. This yield is higher than that of conventional aluminum oxide production via the Bayer process.

Table 2 shows the approximate decomposition temperature for the different aluminum compounds. Boehmite decomposition occurs at 450° C., while Gibbsite decomposition occurs at around 250° C. In some embodiments, a calcination process takes place at greater than 450° C. for 5-15 minutes to convert these phases to alumina.

TABLE 2

| | Decomposition temperature |
|---|---|
| Phase Composition | to aluminum oxide (° C.) |
| Boehmite [γ-AlO(OH)] | 450 |
| Aluminum Oxide - gamma [Al_{2.144}O_{3.2}] | N.A |
| Corundum [Al₂O₃] | N.A |
| Boehmite [γ-AlO(OH)] | 450 |
| Gibbsite [∝-Al(OH)₃] | 250 |

### Exemplary Embodiments

1) A method of preparing aluminum oxide comprising calcining a spent Claus catalyst, wherein the catalyst comprises at least 75% alumina compounds.
2) The method of Embodiment 1, wherein the calcining comprises heating at a temperature of at least 450° C.
3) The method of Embodiment 1 or 2, wherein the calcining is carried out for a time between about 1 minute and about 20 minutes.
4) The method of any one of Embodiments 1 to 3, wherein the alumina compounds comprise boehmite, γ-aluminum oxide, corundum, gibbsite, or a combination thereof.
5) The method of any one of Embodiments 1 to 4, wherein the catalyst comprises about 35 wt. % to about 65 wt. % boehmite.
6) The method of any one of Embodiments 1 to 5, wherein the catalyst comprises about 30 wt. % to about 50 wt. % γ-aluminum oxide.
7) The method of any one of Embodiments 1 to 6, wherein the catalyst comprises about 5 wt. % to about 25 wt. % corundum.
8) The method of any one of Embodiments 1 to 7, wherein the catalyst comprises about 0.01 wt. % to about 5 wt. % gibbsite.
9) The method of any one of Embodiments 1 to 8, wherein the catalyst comprises:
   about 35 wt. % to about 65 wt. % boehmite;
   about 30 wt. % to about 50 wt. % γ-aluminum oxide;
   about 5 wt. % to about 25 wt. % corundum; and
   about 0.01 wt. % to about 5 wt. % gibbsite.
10) The method of any one of Embodiments 1 to 9, wherein the method provides at least 65% yield of the aluminum oxide.
11) A method of preparing aluminum oxide comprising calcining a mixture of alumina compounds, wherein the alumina compounds comprise boehmite, γ-aluminum oxide, corundum, and gibbsite.
12) The method of Embodiment 11, wherein the calcining comprises heating at a temperature of at least 450° C.
13) The method of Embodiment 11 or 12, wherein the calcining is carried out for a time between about 1 minute and about 20 minutes.
14) The method of any one of Embodiments 11 to 13, wherein the mixture comprises about 35 wt. % to about 65 wt. % boehmite.
15) The method of any one of Embodiments 11 to 14, wherein mixture comprises about 30 wt. % to about 50 wt. % γ-aluminum oxide.
16) The method of any one of Embodiments 11 to 15, wherein the mixture comprises about 5 wt. % to about 25 wt. % corundum.
17) The method of any one of Embodiments 11 to 16, wherein the mixture comprises about 0.01 wt. % to about 5 wt. % gibbsite.
18) The method of any one of Embodiments 11 to 17, wherein the mixture comprises:
   about 35 wt. % to about 65 wt. % boehmite;
   about 30 wt. % to about 50 wt. % γ-aluminum oxide;
   about 5 wt. % to about 25 wt. % corundum; and
   about 0.01 wt. % to about 5 wt. % gibbsite.
19) The method of any one of Embodiments 11 to 18, wherein the method provides at least 65% yield of the aluminum oxide.
20) The method of any one of Embodiments 11 to 19, wherein the mixture is essentially free of bauxite.

Other implementations are also within the scope of the following claims.

What is claimed is:

1. A method of preparing aluminum oxide comprising calcining a spent Claus catalyst, wherein the catalyst comprises at least 75% alumina compounds.

2. The method of claim 1, wherein the calcining comprises heating at a temperature of at least 450° C.

3. The method of claim 1, wherein the calcining is carried out for a time between about 1 minute and about 20 minutes.

4. The method of claim 1, wherein the alumina compounds comprise boehmite, γ-aluminum oxide, corundum, gibbsite, or a combination thereof.

5. The method of claim 1, wherein the catalyst comprises about 35 wt. % to about 65 wt. % boehmite.

6. The method of claim 1, wherein the catalyst comprises about 30 wt. % to about 50 wt. % γ-aluminum oxide.

7. The method of claim 1, wherein the catalyst comprises about 5 wt. % to about 25 wt. % corundum.

8. The method of claim 1, wherein the catalyst comprises about 0.01 wt. % to about 5 wt. % gibbsite.

9. The method of claim 1, wherein the catalyst comprises:
about 35 wt. % to about 65 wt. % boehmite;
about 30 wt. % to about 50 wt. % γ-aluminum oxide;
about 5 wt. % to about 25 wt. % corundum; and
about 0.01 wt. % to about 5 wt. % gibbsite.

10. The method of claim 1, wherein the method provides at least 65% yield of the aluminum oxide.

11. A method of preparing aluminum oxide comprising calcining a mixture of alumina compounds, wherein the alumina compounds comprise boehmite, γ-aluminum oxide, corundum, and gibbsite.

12. The method of claim 11, wherein the calcining comprises heating at a temperature of at least 450° C.

13. The method of claim 11, wherein the calcining is carried out for a time between about 1 minute and about 20 minutes.

14. The method of claim 11, wherein the mixture comprises about 35 wt. % to about 65 wt. % boehmite.

15. The method of claim 11, wherein mixture comprises about 30 wt. % to about 50 wt. % γ-aluminum oxide.

16. The method of claim 11, wherein the mixture comprises about 5 wt. % to about 25 wt. % corundum.

17. The method of claim 11, wherein the mixture comprises about 0.01 wt. % to about 5 wt. % gibbsite.

18. The method of claim 11, wherein the mixture comprises:
about 35 wt. % to about 65 wt. % boehmite;
about 30 wt. % to about 50 wt. % γ-aluminum oxide;
about 5 wt. % to about 25 wt. % corundum; and
about 0.01 wt. % to about 5 wt. % gibbsite.

19. The method of claim 11, wherein the method provides at least 65% yield of the aluminum oxide.

20. The method of claim 11, wherein the mixture is essentially free of bauxite.
